(19) United States
(12) Patent Application Publication
(10) Pub. No.: US 2014/0068239 A1
(43) Pub. Date: Mar. 6, 2014

(54) METHOD FOR BOOTING ICON LOCKOUT

(71) Applicant: Han-Sheng YANG, New Taipei City (TW)

(72) Inventor: Han-Sheng YANG, New Taipei City (TW)

(21) Appl. No.: 13/596,992

(22) Filed: Aug. 28, 2012

(51) Int. Cl. G06F 9/00

(52) U.S. Cl. 713/2

(57) ABSTRACT

The present invention relates to a method for booting icon lockout and comprises steps as follows: (1) Configure a display mode of a host computer's graphic chip as “graphic” in order to define memory addresses in the host computer to be a memory pool for icon display; (2) Decompress the zip file for a customized booting icon which is saved in the BIOS chip as one file; (3) Load the file to the memory pool and map the file to the graphic chip's memories for displaying the customized booting icon on a monitor; (4) Change content of the call function (INT10H) in order to smoothly display nothing except the identical customized booting icon on a monitor by INT10H in a boot process from power-on self-test to desktop display before OS is completely loaded.

### BACKGROUND OF THE INVENTION

1. Field of the Invention

The present invention relates to a method for booting icon lockout, particularly a method to smoothly display an identical customized icon during a boot process.

2. Description of the Related Art

The boot process of a host computer can be divided into two stages based on an execution sequence: (1) Pre-stage: power-on self-test; (2) Post-stage: operating system loading. The power-on self-test is to load the Basic Input/Output System (hereinafter referred to as BIOS) into memories. As a bridge between hardware and the operating system to be loaded later, BIOS is used in hardware initialization, software detection and hardware parameter configuration in a boot process; this boot process will be formally completed later with Operating System (OS) loaded by Boot Loader.

In general, information regarding motherboard, BIOS loading, hardware (e.g., RAM) test, initialization, etc. should be displayed on a monitor with BIOS loaded by each host computer. In this stage, the information is usually indicated in a text mode (white texts on a black background or white texts on a blue background) until a graphic chip is configured to graphic mode with OS loaded by Boot Loader.

To reinforce enterprise image or advertising effect, a computer user serving in an enterprise expects to display a company logo or critical products on a computer monitor in a boot process until OS is ready. On the other side, a personal computer user likes to see a favorable or commemorative picture on a computer monitor and makes his/her computer animating or personalized in a boot process until OS is ready, that is, a customized picture is always kept on a monitor in a boot process. The common practice for displaying a customized icon is to directly change an OS parameter (e.g., “operating systems” in boot.ini) during a boot process (FIG. 1). For one computer in a boot process, power-on self-test is followed by display of a customized icon and OS loading in which display of a OS loading and the customized icon disappears because of a desktop loaded and OS ready.

However, there are two shortcomings in the practice hereinbefore: (1) risks of losing security and stability of OS due to direct change of OS configurations: a company stressing security and stability cannot accept change of a customized icon in virtue of system restore, falsification or OS formatting; (2) transition from a customized icon to a desktop is unsmooth. Accordingly, an identical customized icon smoothly displayed in a host computer's boot process from power-on self-test to desktop ready under prerequisites of no change in OS parameters and system secure and stable has become one issue deserving to be studied

### SUMMARY OF THE INVENTION

The object of the present invention is to provide a method for booting icon lockout which controls a host computer to display an identical booting icon without change of any OS (operating system) file or parameter during the boot process from power-on self-test (POST) to desktop ready. Furthermore, the present invention is executed in conjunction with the boot process of a host computer in which there is at least a chip with BIOS codes and at least a zip file for a customized booting icon included. The method comprising the following steps:

Step 1: Configure a display mode of a host computer's graphic chip as “graphic” in order to define memory addresses in the host computer to be a memory pool for icon display;

Step 2: Decompress the zip file for a customized booting icon which is saved in the chip as a file for a customized booting icon;

Step 3: Load the file for a customized booting icon to the memory pool and map the file to the graphic chip's memories for displaying the customized booting icon on a monitor;

Step 4: Change content of the call function (INT10H) in order to display nothing except the customized booting icon on a monitor by INT10H before OS is completely loaded.

In the abovementioned characteristics, the zip file for a customized booting icon has a format such as JPEG, PNG, TIF or BMP and is compressed, encoded and saved in the BIOS chip in advance.

In the abovementioned characteristics, the memory pool for icon display is defined in memory addresses A000H˜B000H.

### BRIEF DESCRIPTION OF THE DRAWINGS

FIG. 1 is a flowchart of the boot process executed in a host computer based on prior arts.

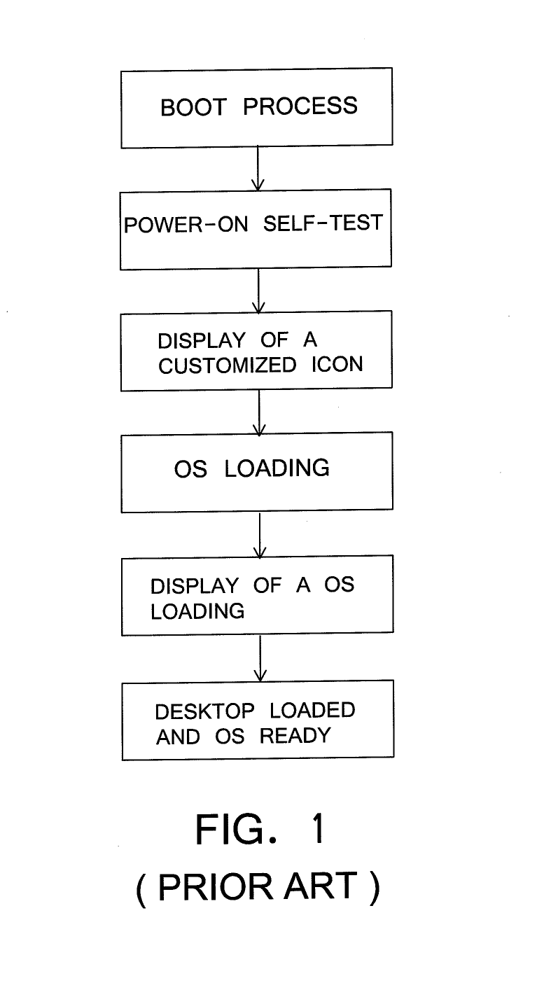

FIG. 2 is a flowchart of a customized icon displayed and disappearing in a boot process with respect to the present invention of a method for booting icon lockout

FIG. 3 is a flowchart to execute the method for booting icon lockout in the present invention.

FIG. 4 is a schematic view for the architecture of a host computer in the present invention of a method for booting icon lockout.

### DETAILED DESCRIPTION OF THE PREFERRED EMBODIMENTS

For the objects hereinbefore, the technical measures adopted in the present disclosure and their effects are explained in preferred embodiments and appended diagrams.

It is notable that a customized booting icon described in the present disclosure depends on actual requirements and includes, without limitation, an enterprise's trademark, product logo, service picture, and warning icon (e.g., confidential warning) or a person's favorable picture and photo.

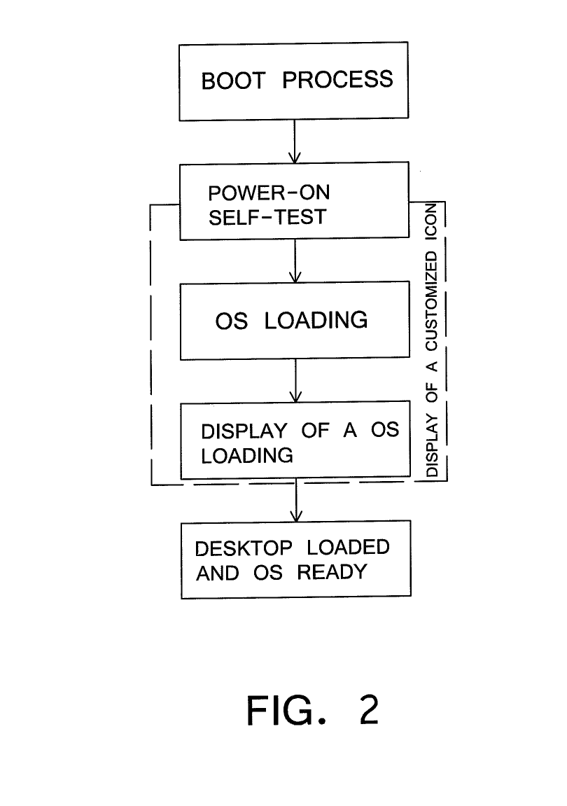

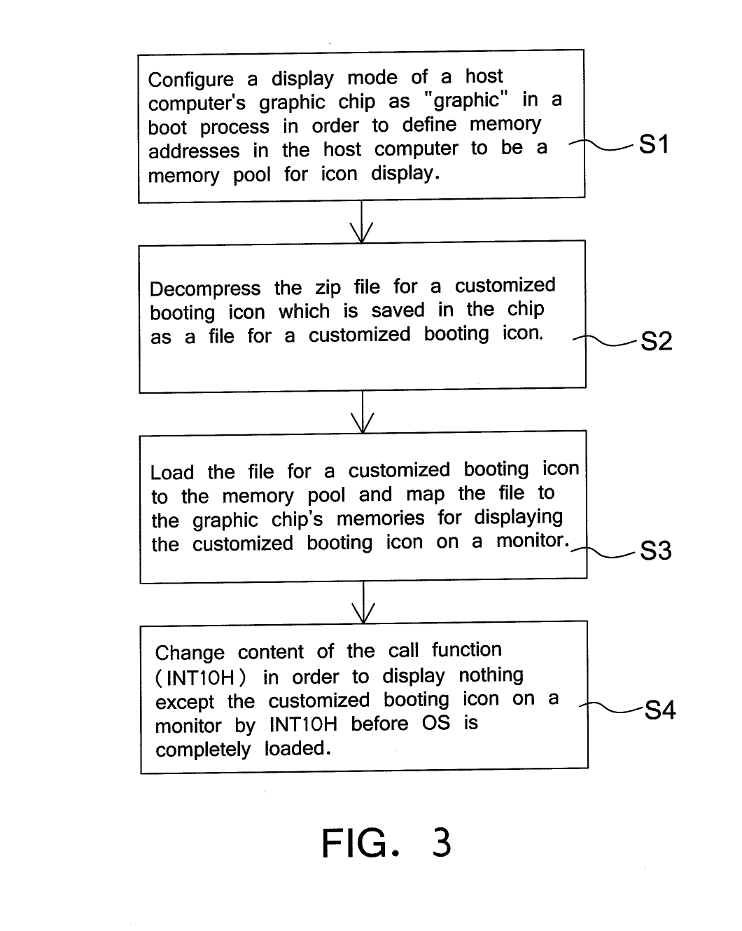

Referring to FIGS. 2 and 3 wherein FIG. 2 is a flowchart of a customized icon displayed and disappearing in a boot process with respect to the present invention of a method for booting icon lockout and FIG. 3 is a flowchart to execute the present invention of a method for booting icon lockout.

As shown in FIGS. 2 and 3, the present invention provides a method for booting icon lockout which is executed in conjunction with a host computer's boot process; the present invention relies on the host computer's different graphic memory addresses to be accessed in distinct display modes (e.g., text mode and graphic mode) and proactively controls the host computer to display a customized icon without change of any OS file or parameter during the boot process from power-on self-test (POST) to desktop ready but overwrites the icon until the desktop content is presented (FIG. 2). The host computer described in the present invention comprises a motherboard with a chip in which at least BIOS codes and a zip file for a booting icon are saved. The method includes steps as follow:

Step 1: Configure a display mode of a host computer's graphic chip as “graphic” in a boot process in order to define memory addresses in the host computer to be a memory pool for icon display (S1);

Step 2: Decompress the zip file for a customized booting icon which is saved in the chip as a file for a customized booting icon (S2);

Step 3: Load the file for a customized booting icon to the memory pool and map the file to the graphic chip's memories for displaying the customized booting icon on a monitor (S3);

Step 4: Change content of the call function (INT10H) in order to display nothing except the customized booting icon on a monitor by INT10H before OS is completely loaded (S4).

The zip file for a customized booting icon which has a format such as JPEG, PNG, TIF or BMP is compressed and encoded as binary codes and saved in the BIOS chip in advance.

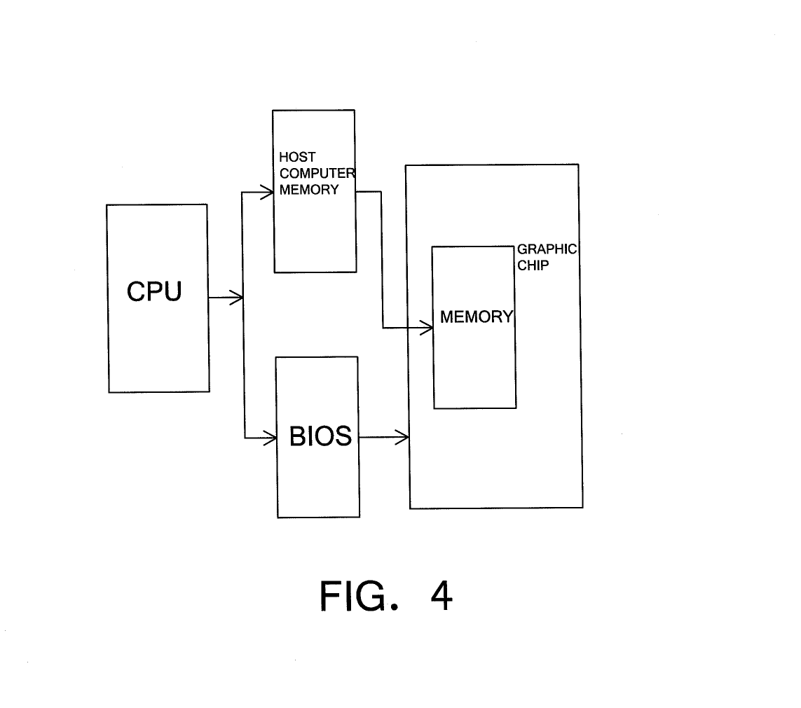

Referring to FIG. 4 which is a schematic view of the host computer's architecture applicable to the present invention of a method for booting icon lockout.

As shown in FIG. 4, the host computer will access its different memory addresses with the graphic chip configured as distinct display modes. In general, the memory segmentation (64K; memory addresses from A000H to B000H) is allotted to the graphic chip by the host computer for saving and accessing content to be displayed with the graphic chip configured to a graphic mode, that is, content saved in the memory segmentation is directly displayed on a monitor until the content is overwritten. Similarly, the memory segmentation (32K; memory addresses from B800H to C000H) is allotted to the graphic chip by the host computer for saving and accessing content to be displayed with the graphic chip configured to a text mode. Based on this characteristic in a computer architecture, the present invention is able to complete the following steps: (a) Configure a display mode of a host computer's graphic chip as “graphic” in a boot process in order to define a memory segmentation (memory addresses: A000H˜B000H) to be a memory pool for icon display by the host computer (S1); (In the present invention, the method to configure the graphic chip's display mode is not particularly specified, for instance, the graphic chip can be configured as a graphic mode with an interrupt request issued by INT10H. Then, the memory addresses (A000H˜B000H) will be immediately allotted to corresponding memories of the graphic chip for accessing or saving data by the host computer with the abovementioned configuration completed.) (b) Decompress the zip file for a customized booting icon which is saved in the chip as a file for a customized booting icon (S2); (c) Load the file for a customized booting icon to the memory pool and map the file to the graphic chip's memories for displaying the customized booting icon on a monitor (S3); (d) Change content of the call function (INT10H) in order to display nothing except the customized booting icon on a monitor by INT10H before OS is completely loaded (S4). As such, the customized booting icon in previous steps is continuously displayed on a monitor and not overwritten until OS is completely loaded (or a desktop is ready).

The detailed descriptions are further shown as follows. The original call function, INT10H, is intended for keeping a standard desktop to display execution results on a monitor and overwrite a customized icon based on prior arts, that is, content accessed by OS is displayed on the desktop. The example for content of the original call function, INT10H, is shown as follows:

MOV BL, 035H

MOV AX 05F05H

RET

In the same example, content of the revised call function, INT10H, is shown as follows: RET

As shown above, no result is feedback to a monitor with the revised call function, INT10H, executed and continuously enabled. In contrast to prior arts, the present invention does not disturb stability and security of OS because INT10H is still ongoing.

The function of the present invention can be directly incorporated into current BIOS codes of any edition in which there is neither revision of existing VBIOS (Visual BIOS) nor modification of source codes provided by a chip design house, so as to keep a customized icon before the desktop ready, optimize a customer's options, and promote stability, security and cross-platform flexibility for both software and hardware.

In summary, the present invention features configuring a graphic chip as a graphic mode in order to display a complete customized icon on a monitor before the graphic chip's driver is loaded by OS during the initial power-on stage; the present invention changes content of the call function, INT10H, in order to display nothing except the identical and non-overwritten customized booting icon on a monitor by INT10H during the boot process from power-on self-test (POST) to desktop ready.

The above descriptions present preferred embodiments of the present invention only and do not limit the scope of the present invention; any equivalent change or improvement based on the disclosed technical measures should be within the scope of the present invention.

What is claimed is:

1. A method for booting icon lockout synchronously executed in a boot process of a host computer in which there is a motherboard chip with BIOS codes and at least a zip file for a customized booting icon saved, and comprising:
Step 1: Configure a display mode of a host computer's graphic chip as “graphic” in order to define memory addresses in the host computer to be a memory pool for icon display;
Step 2: Decompress the zip file for a customized booting icon which is saved in the chip as a file for a customized booting icon;
Step 3: Load the file for a customized booting icon to the memory pool and map the file to the graphic chip's memories for displaying the customized booting icon on a monitor;
Step 4: Change content of the call function (INT10H) in order to display nothing except the customized booting icon on a monitor by INT10H before OS is completely loaded (or a desktop is ready).

2. The method for booting icon lockout according to claim 1 wherein said zip file for a customized booting icon has a format such as JPEG, PNG, TIF or BMP and is compressed, encoded, and saved in said BIOS chip in advance.

3. The method for booting icon lockout according to claim 1 wherein said memory pool for icon display is defined in memory addresses A000H˜B000H.
